(19) United States
(12) Patent Application Publication
(10) Pub. No.: US 2018/0254486 A1
(43) Pub. Date: Sep. 6, 2018

(54) NEGATIVE ELECTRODE ACTIVE MATERIAL, NEGATIVE ELECTRODE AND LITHIUM ION SECONDARY BATTERY

(71) Applicant: TDK CORPORATION, Tokyo (JP)

(72) Inventors: Takuya AOKI, Tokyo (JP); Yasuyuki KAWANAKA, Tokyo (JP)

(73) Assignee: TDK CORPORATION, Tokyo (JP)

(21) Appl. No.: 15/909,580

(22) Filed: Mar. 1, 2018

(30) Foreign Application Priority Data
Mar. 3, 2017 (JP) 2017-040753
Jan. 22, 2018 (JP) 2018-008441

(51) Int. Cl. H01M 4/62; H01M 10/0525; H01M 10/04; H01M 4/64

(52) U.S. Cl. CPC H01M 4/623; H01M 10/0525; H01M 2004/027; H01M 4/64; H01M 4/625; H01M 10/0459

(57) ABSTRACT

A negative electrode active material includes a carbon material, and at least one sulfur component selected from the group consisting of sulfur atoms and a sulfur compound, wherein a content of the sulfur component with respect to a total amount of the carbon material and the sulfur component is 0.0005 mass % or more and 0.01 mass % or less in terms of S measured by a fluorescent X-ray analysis method, the carbon material is artificial graphite, and the artificial graphite has a bulk density of 0.2 g/cm³ or more and 2.5 g/cm³ or less. A negative electrode includes a negative electrode current collector, and a negative electrode active material layer formed on the negative electrode current collector, wherein the negative electrode active material layer includes the above-described negative electrode active material. A lithium ion secondary battery includes the above-described negative electrode, a positive electrode, and an electrolytic solution.

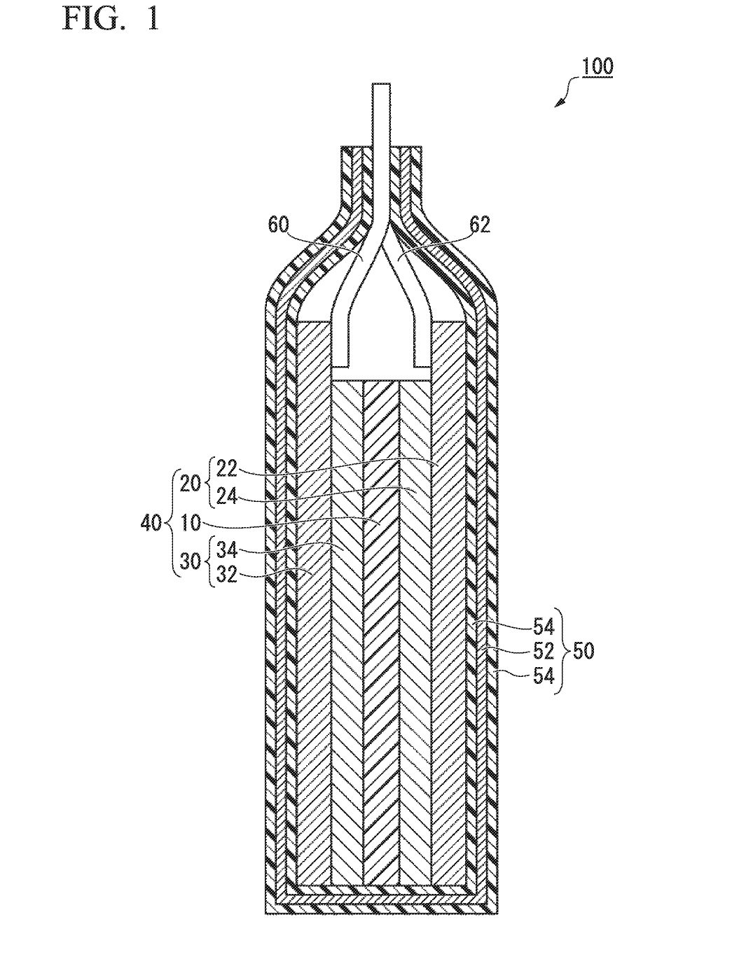

### BACKGROUND OF THE INVENTION

### Field of the Invention

The present invention relates to a negative electrode active material, a negative electrode and a lithium ion secondary battery.

Priority is claimed on Japanese Patent Application No. 2017-040753 filed Mar. 3, 2017, and Japanese Patent Application No. 2018-008441 filed Jan. 22, 2018, the contents of which are incorporated herein by reference.

### Description of Related Art

Lithium ion secondary batteries are widely applied as power sources for portable electronic devices due to being lighter and having a higher capacity than nickel cadmium batteries, nickel hydride batteries, etc. Further, the lithium ion secondary battery is also a promising candidate as a power source to be installed in hybrid vehicles and electric vehicles. With the recent miniaturization and increased functionality of portable electronic devices, there is an expectation of further increase in the capacity of lithium ion secondary batteries serving as power sources for portable electronic devices.

The capacity of a lithium ion secondary battery depends mainly on an active material of an electrode. A carbon material such as graphite is generally used for a negative electrode active material. However, a theoretical capacity of graphite is 372 mAh/g, and a capacity of about 350 mAh/g has been used for batteries which have been put to practical use. Accordingly, it is necessary to further increase the capacity in order to obtain a nonaqueous electrolyte secondary battery having a sufficient capacity as an energy source of future multi-functional portable devices.

In recent years, in addition to yet higher capacity, the demand for rapid discharge has been increasing due to rapid charging characteristics for improving convenience and the development of new applications for lithium ion secondary batteries such as in electric tools and cordless home appliances.

Patent Document 1 discloses a lithium ion secondary battery in which a sulfur component of a carbon material of a negative electrode is specified as being 5% or less. In Patent Document 1, a lithium ion secondary battery having high cycle characteristics and excellent storage characteristics is provided by suppressing the reaction between the sulfur component in the carbon material and lithium.

### PATENT DOCUMENTS

[Patent Document 1] Japanese Unexamined Patent Application, First Publication No. H4-126373

### SUMMARY OF THE INVENTION

However, rapid charging characteristics are insufficient in the lithium ion secondary battery described in Patent Document 1.

The present invention has been made in view of the above-described problems, and an object of the present invention is to provide a negative electrode active material, a negative electrode, and a lithium ion secondary battery having excellent rapid charging characteristics.

The present inventors found that a lithium ion secondary battery, in which a composition containing a predetermined carbon material and a predetermined amount of a sulfur component is used as a negative electrode active material, has improved rapid charging characteristics.

That is, the present invention provides the following means to solve the problems.

(1) A negative electrode active material according to a first embodiment includes a carbon material, and at least one sulfur component selected from the group consisting of sulfur atoms and a sulfur compound, in which a content of the sulfur component with respect to a total amount of the carbon material and the sulfur component is 0.0005 mass % or more and 0.01 mass % or less in terms of S measured by a fluorescent X-ray analysis method, the carbon material is artificial graphite, and the artificial graphite has a bulk density of 0.2 g/cm³ or more and 2.5 g/cm³ or less.

(2) In the negative electrode active material according to the embodiment, the content of the sulfur component may be 0.009 mass % or less in terms of S measured by a fluorescent X-ray analysis method.

(3) In the negative electrode active material according to the embodiment, the content of the sulfur component may be 0.005 mass % or less in terms of S measured by a fluorescent X-ray analysis method.

(4) In the negative electrode active material according to the embodiment, the artificial graphite may have a bulk density of 0.5 g/cm³ or more and 2.0 g/cm³ or less.

(5) In the negative electrode active material according to the embodiment, the artificial graphite may have a specific surface area of 0.1 m²/g or more and 2 m²/g or less.

(6) A negative electrode according to a second embodiment includes a negative electrode current collector, and a negative electrode active material layer formed on the negative electrode current collector, and the negative electrode active material layer includes the negative electrode active material according to the embodiment.

(7) In the negative electrode active material according to the embodiment, the negative electrode active material layer may contain the negative electrode active material in an amount of 92 mass % or more and 98 mass % or less, a binder in an amount of 1 mass % or more and 3 mass % or less, a conductive material in an amount of 0 mass % or more and 3 mass % or less, and a thickener in an amount of 0 mass % or more and 2 mass % or less.

(8) A lithium ion secondary battery according to a third embodiment includes the negative electrode according to the embodiment, a positive electrode, and an electrolytic solution.

(9) In the lithium ion secondary battery according to the embodiment, the electrolytic solution may contain a cyclic carbonate and a chain carbonate, and a ratio X/Y of a content X of the cyclic carbonate to a content Y of the chain carbonate is in a range of 1 or more and 5 or less as a volume ratio.

The negative electrode active material, negative electrode and lithium ion secondary battery according to the embodiment have excellent rapid charging characteristics.

### BRIEF DESCRIPTION OF THE DRAWINGS

FIGURE is a schematic cross-sectional view of a lithium ion secondary battery according to an embodiment of the present invention.

### DETAILED DESCRIPTION OF THE INVENTION

Hereinafter, an embodiment of the present invention will be described in detail with appropriate reference to the drawing. In the drawing used in the following description, for the sake of easy understanding of the features of the present invention, there are cases where characteristic portions are enlarged for the sake of convenience, and the dimensional proportions of each component may be different from the actual ones. Materials and sizes and the like in the following description are merely exemplary examples, and the present invention is not limited thereto and is able to be realized by modification as appropriate within a range not changing the gist thereof.

Lithium Ion Secondary Battery FIGURE is a schematic cross-sectional view of a lithium ion secondary battery according to an embodiment of the present invention. The lithium ion secondary battery 100 shown in FIGURE mainly includes a laminate 40, a case 50 for housing the laminate 40 in a sealed state, and a pair of leads 60 and 62 connected to the laminate 40. Although not shown, an electrolytic solution is contained in the case 50 together with the laminate 40.

The laminate 40 is formed by disposing a positive electrode 20 and a negative electrode 30 to face each other with a separator 10 interposed therebetween. The positive electrode 20 is formed by providing a positive electrode active material layer 24 on a plate-like (film-like) positive electrode current collector 22. The negative electrode 30 is formed by providing a negative electrode active material layer 34 on a plate-like (film-like) negative electrode current collector 32.

The positive electrode active material layer 24 and the negative electrode active material layer 34 are in contact with both sides of the separator 10. Ends of the positive electrode current collector 22 and the negative electrode current collector 32 are respectively connected to the leads 60 and 62. Ends of the leads 60 and 62 extend out of the case 50. Although one laminate 40 is included in the case 50 in FIGURE, a plurality of the laminates 40 may be stacked.

Negative Electrode

The negative electrode 30 includes a negative electrode current collector 32, and a negative electrode active material layer 34 formed on the negative electrode current collector 32.

Negative Electrode Current Collector

The negative electrode current collector 32 may be a conductive plate material, and for example, a thin metal plate formed of aluminum, copper, or nickel foil may be used.

Negative Electrode Active Material Layer

The negative electrode active material layer 34 includes a negative electrode active material and a negative electrode binder, and as necessary, includes a negative electrode conductive material.

Negative Electrode Active Material

The negative electrode active material includes a carbon material, and at least one sulfur component selected from the group consisting of sulfur atoms and a sulfur compound.

Artificial graphite is used as the carbon material.

The artificial graphite has a bulk density of 0.2 g/cm³ or more and 2.5 g/cm³ or less, and preferably of 0.5 g/cm³ or more and 2.0 g/cm³ or less. A negative electrode active material layer formed using artificial graphite having a bulk density in the above-described range is liable to generate relatively large voids to such an extent that the electrolytic solution may penetrate therein, so that transfer of lithium ions between the artificial graphite and the electrolyte becomes easy, and the rapid charging characteristics tend to further increase. The bulk density is the ratio of the weight of the artificial graphite to the volume of a container when a container having a predetermined capacity is filled with the artificial graphite.

Preferably, the artificial graphite has a specific surface area of 0.1 m²/g or more and 2 m²/g or less. In the negative electrode active material layer in which artificial graphite having a specific surface area in the above-described range is used, the contact surface between the artificial graphite and the electrolyte becomes more extensive so that transfer of lithium ions between the artificial graphite and the electrolytic solution becomes easy, and the rapid charging characteristics tend to further increase. Further, the specific surface area is a value measured by a BET method by nitrogen gas adsorption.

The sulfur component contained in the negative electrode active material according to an embodiment of the present invention has an action of improving the rapid charging characteristics of the lithium ion secondary battery. The reason why the rapid charging characteristics of the lithium ion secondary battery, in which the negative electrode active material containing a sulfur component is used, is improved is thought to be that sulfur atoms contained in the sulfur component exist on the surface or inside of the carbon material and improve the Li ion conductivity of the carbon material. Accordingly, it is preferable that the sulfur component is present on the surface or between layers of the carbon material. It is preferable that sulfur of the sulfur component present on the surface or between layers of the carbon material chemically bonds with carbon of the carbon material to form, for example, carbon monosulfide (CS). When sulfur of the sulfur component and carbon are chemically bonded to each other, the sulfur component contained in the negative electrode active material is less likely to be eluted into the electrolyte, and the Li ion conductivity of the carbon material stably improves over a long period of time. The amount of sulfur of the negative electrode active material eluted into the electrolyte may be an amount such that, for example, when 3 g of the negative electrode active material is stirred for 10 hours in 100 mL of an electrolytic solution (a solvent in which EC and DEC are mixed together at a volume ratio of 3:7), an amount of increase in the sulfur content of the electrolyte is 0.0003 mass % or less. Preferably, the amount of increase in the sulfur content of the electrolytic solution is 0.0002 mass % or less.

The sulfur component is selected from the group consisting of sulfur atoms and a sulfur compound. Examples of sulfur compounds include sulfur oxides and lithium sulfides. The sulfur component may be either one of sulfur atoms or the sulfur compound or both of sulfur atoms and the sulfur compound.

In an embodiment of the present invention, the content of the sulfur component is 0.0005 mass % or more and 0.01 mass % or less in terms of S (sulfur) with respect to the total amount of the negative electrode active material (the total amount of the carbon material and the sulfur component). Further, the content of the sulfur component (in terms of S) is a value measured by a fluorescent X-ray analysis method. In order to reliably improve the rapid charging characteristics of the lithium ion secondary battery, the content of the sulfur component is preferably 0.009 mass % or less, and more preferably is 0.005 mass % or less in terms of S.

In the negative electrode active material according to an embodiment of the present invention, it is preferable that the content of metal atoms which are likely to bond with sulfur atoms and form a sulfide is small. The carbon material preferably has a small content of alkali metals, and particularly, a small content of potassium. Specifically, the content of potassium is preferably 0.0001 mass % or less. Further, the content of potassium is a value measured by a fluorescent X-ray analysis method.

Method of Preparing Negative Electrode Active Material

For example, the negative electrode active material according to an embodiment of the present invention may be prepared by mixing a carbon material and a sulfur source at a ratio such that the content of sulfur component is within the aforementioned range in terms of S. Examples of the sulfur source include gases, solids and liquids. Examples of gaseous sulfur sources include hydrogen sulfide and sulfur dioxide. Examples of solid sulfur sources include sulfur, metal sulfides and metal sulfates. Examples of metal sulfides include, for example, lithium sulfide. Examples of metal sulfates include, for example, lithium sulfate, magnesium sulfate, calcium sulfate and barium sulfate. Examples of liquid sulfur sources include solutions of sulfur-containing oxoacids such as sulfuric acid, sulfurous acid and disulfurous acid. A mixing method may be wet mixing or dry mixing. Mixing of the carbon material and the sulfur source is preferably carried out while applying mechanical energy such as impact, compression, shear, shear stress, friction and the like to the carbon material and the sulfur source. Accordingly, the crystal structure of the carbon material and the sulfur source changes or the surfaces of particles are activated so that the carbon material and the sulfur source are chemically bonded to each other to generate carbon monosulfide (CS). This reaction is called a mechanochemical reaction, which is used in the fields of pigments, ceramics, electronic materials, magnetic materials, medicines, pesticides, foods, etc. As a mixing device, a mixing device used for a mechanochemical reaction such as a ball mill may be used.

Negative Electrode Conductive Material

Examples of the conductive material include carbon powders such as carbon black, carbon nanotubes, a carbon material, fine metal powders of such as copper, nickel, stainless steel, iron and the like, a mixture of a carbon material and a fine metal powder, and a conductive oxide such as ITO. Among these, carbon powders such as acetylene black, ethylene black and the like are particularly preferable. In the case where sufficient conductivity can be ensured using only the negative electrode active material, the lithium ion secondary battery 100 may not include a conductive material.

Negative Electrode Binder

A binder bonds active materials to each other and bonds the active material to the negative electrode current collector 32. The binder may be any material as long as it enables the aforementioned bonding, and examples thereof include fluorine resins such as polyvinylidene fluoride (PVDF), polytetrafluoroethylene (PTFE), a tetrafluoroethylene-hexafluoropropylene copolymer (FEP), a tetrafluoroethylene-perfluoroalkylvinylether copolymer (PFA), an ethylene-tetrafluoroethylene copolymer (ETFE), polychlorotrifluoroethylene (PCTFE), an ethylene-chlorotrifluoroethylene copolymer (ECTFE), polyvinyl fluoride (PVF), etc.

In addition, further examples of the binder include vinylidene fluoride-based fluorine rubbers such as a vinylidene fluoride-hexafluoropropylene-based fluorine rubber (VDF-HFP-based fluorine rubber), a vinylidene fluoride-hexafluoropropylene-tetrafluoroethylene-based fluorine rubber (VDF-HFP-TFE-based fluorine rubber), a vinylidene fluoride-pentafluoropropylene-based fluorine rubber (VDF-PFP-based fluorine rubber), a vinylidene fluoride-pentafluoropropylene-tetrafluoroethylene-based fluorine rubber (VDF-PFP-TFE-based fluorine rubber), a vinylidene fluoride-perfluoromethylvinylether-tetrafluoroethylene-based fluorine rubber (VDF-PFMVE-TFE-based fluorine rubber), a vinylidene fluoride-chlorotrifluoroethylene-based fluorine rubber (VDF-CTFE-based fluorine rubber), etc.

Further, an electron-conductive polymer or an ion-conductive polymer may be used as the binder. An example of the electron-conductive polymer includes polyacetylene or the like. In this case, since the binder also functions as a conductive material, it is not necessary to add a conductive material. An example of the ion-conductive polymer includes a composite of a polymer compound of a monomer (a polyether-based polymer compound such as polyethylene oxide, polypropylene oxide and the like, polyphosphazene and the like), and a lithium salt such as LiClO₄, LiBF₄, LiPF₆ and the like, or an alkali metal salt containing lithium as a main component and the like. An example of a polymerization initiator used for forming the composite includes a photopolymerization initiator or a thermal polymerization initiator which is applicable to the monomer.

In addition, for example, cellulose, styrene-butadiene rubber (SBR), ethylene-propylene rubber, a polyimide resin, a polyamideimide resin, an acrylic resin or the like may be used as the binder.

Thickener

An example of a thickener is carboxymethyl cellulose (CMC).

The contents of the negative electrode active material, conductive material and binder in the negative electrode active material layer 34 are not particularly limited. The compositional proportion of the negative electrode active material in the negative electrode active material layer 34 is preferably 92 mass % or more and 98 mass % or less by proportion by mass. In addition, the compositional proportion of the conductive material in the negative electrode active material layer 34 is preferably 0 mass % or more and 3.0 mass % or less by proportion by mass, and the compositional proportion of the binder in the negative electrode active material layer 34 is preferably 2.0 mass % or more and 5.0 mass % or less by proportion by mass. Further, the negative electrode active material layer 34 may contain the negative electrode active material in an amount of 92 mass % or more and 98 mass % or less, the binder in an amount of 1 mass % or more and 3 mass % or less, the conductive material in an amount of 0 mass % or more and 3 mass % or less and the thickener in an amount of 0 mass % or more and 2 mass % or less.

When the contents of the negative electrode active material and the binder are in the aforementioned ranges, the amount of binder being too small to form a strong negative electrode active material layer may be prevented. Also, the amount of binder which does not contribute to the electrical capacitance increases, and thus it is also possible to curb a tendency of a sufficient volume energy density not being able to be obtained.

The bulk density of the negative electrode active material layer 34 according to an embodiment of the present invention is preferably 0.5 g/cm³ or more and 2.0 g/cm³ or less.

In this case, since the bulk density of the negative electrode active material layer is 0.5 g/cm³ or more, the capacity is increased. In addition, since the bulk density of the negative electrode active material layer is 2.0 g/cm³ or less, the negative electrode active material layer has voids, so that the contact area between the negative electrode active material and a nonaqueous electrolyte is extensive, transfer of Li ions between the negative electrode active material and the nonaqueous electrolyte is facilitated, and rapid charging characteristics are further improved.

Positive Electrode

The positive electrode 20 includes the positive electrode current collector 22, and a positive electrode active material layer 24 formed on the positive electrode current collector 22.

Positive Electrode Current Collector

The positive electrode current collector 22 may be a conductive plate material, and for example, a thin metal plate formed of aluminum, copper, or nickel foil may be used.

Positive Electrode Active Material Layer

As the positive electrode active material used in the positive electrode active material layer 24, an electrode active material which allows occlusion and release of lithium ions, desorption and insertion of lithium ions (intercalation), or doping and undoping of lithium ions and counter anions of the lithium ions (such as PF₆⁻) to proceed reversibly may be used.

Examples of the positive electrode active material include lithium cobaltate (LiCoO₂), lithium nickelate (LiNiO₂), lithium manganate (LiMnO₂), lithium manganese spinel (LiMn₂O₄), and mixed metal oxides such as those expressed by the general formula of LiNiₓCo_{y}Mn_{z}MₐO₂ (where x+y+z+a=1, 0≤x<1, 0≤y<1, 0≤z<1, 0≤a<1, and M is at least one type of element selected from Al, Mg, Nb, Ti, Cu, Zn, and Cr), a lithium vanadium compound (LiV₂O₅), olivine-type LiMPO₄ (where M is at least one type of element selected from Co, Ni, Mn, Fe, Mg, Nb, Ti, Al, and Zr, or VO), lithium titanate (Li₄Ti₅O₁₂), composite metal oxides such as LiNiₓCo_{y}Al_{z}O₂ (0.9<x+y+z<1.1), polyacetylene, polyaniline, polypyrrole, polythiophene, polyacene, etc.

Conductive Material

Examples of the conductive material include carbon powders such as carbon black, carbon nanotubes, a carbon material, fine metal powders of such as copper, nickel, stainless steel, iron and the like, a mixture of a carbon material and a fine metal powder, and a conductive oxide such as ITO. In the case where sufficient conductivity can be ensured using only the positive electrode active material, the lithium ion secondary battery 100 may not include a conductive material.

Positive Electrode Binder

The same binders as used in the negative electrode may be used in the positive electrode.

The compositional proportion of the positive electrode active material in the positive electrode active material layer 24 is preferably 80 mass % or more and 96 mass % or less by proportion by mass. Further, the compositional proportion of the conductive material in the positive electrode active material layer 24 is preferably 2.0 mass % or more and 10 mass % or less by proportion by mass, and the compositional proportion of the binder in the positive electrode active material layer 24 is preferably 2.0 mass % or more and 10 mass % or less by proportion by mass.

Separator

The separator 10 may be formed of an electrically insulating porous structure, and examples thereof include a single layer of a film including polyethylene, polypropylene, or a polyolefin, a laminate or a stretched film of the above-described resins or a mixture thereof, or a nonwoven fabric including at least one component material selected from the group consisting of cellulose, polyester, and polypropylene.

Electrolytic Solution

As the electrolytic solution, an electrolyte solution containing a lithium salt (aqueous electrolyte solution, electrolyte solution using an organic solvent) may be used. However, since an aqueous electrolyte solution has a low electrochemical decomposition voltage, the withstand voltage during charging is limited to a low level. Thus, an electrolyte solution (nonaqueous electrolytic solution) which uses an organic solvent is preferable.

The nonaqueous electrolytic solution may contain an electrolyte dissolved in a nonaqueous solvent, and may contain a cyclic carbonate and a chain carbonate as a nonaqueous solvent. The nonaqueous solvent preferably contains a cyclic carbonate and a chain carbonate.

As the cyclic carbonate, those capable of solvating the electrolyte may be used. For example, ethylene carbonate, propylene carbonate, butylene carbonate and the like may be used.

The chain carbonate may lower the viscosity of the cyclic carbonate. For example, diethyl carbonate, dimethyl carbonate, and ethyl methyl carbonate may be used. In addition, methyl acetate, ethyl acetate, methyl propionate, ethyl propionate, γ-butyrolactone, 1,2-dimethoxyethane, 1,2-diethoxyethane and the like may be mixed in and used.

The ratio of the cyclic carbonate to the chain carbonate in the nonaqueous solvent is preferably 1:9 to 1:1 as a volume ratio. A ratio X/Y of a content X of the cyclic carbonate to a content Y of the chain carbonate in the nonaqueous solvent is preferably in a range of 1 or more and 5 or less as a volume ratio. When the same amount or more of a chain carbonate having a relatively low viscosity as that of the cyclic carbonate is included, the nonaqueous electrolytic solution easily permeates into the negative electrode active material layer, so that cycle characteristics are improved.

As the electrolyte, for example, lithium salts such as LiPF₆, LiClO₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB may be used. Further, one type of these lithium salts may be used alone, or two or more types thereof may be used in combination. In particular, it is preferable to include LiPF₆ from the viewpoint of the degree of ionization.

When LiPF₆ is dissolved in a nonaqueous solvent, it is preferable to adjust the concentration of the electrolyte in the nonaqueous electrolytic solution to 0.5 to 2.0 mol/L. When the concentration of the electrolyte is 0.5 mol/L or more, a sufficient lithium ion concentration may be secured for the nonaqueous electrolytic solution, and a sufficient capacity may easily be obtained during charging and discharging. Further, when the concentration of the electrolyte is reduced to be within 2.0 mol/L, an increase in viscosity of the nonaqueous electrolytic solution may be curbed, sufficient mobility may be secured for the lithium ions, and a sufficient capacity may be easily obtained during charging and discharging.

Also in the case where LiPF₆ is mixed with other electrolytes, the lithium ion concentration in the nonaqueous electrolytic solution is preferably adjusted to be 0.5 to 2.0 mol/L, and more preferably, the lithium ion concentration from LiPF₆ is 50 mol % or more.

Case

The case 50 is for housing the laminate 40 and the electrolyte inside in a sealed state. The case 50 is not particularly limited as long as leakage of the electrolytic solution to the outside and intrusion of moisture and the like from outside to the inside of the lithium ion secondary battery 100 can be curbed.

For example, a metal laminate film obtained by coating a metal foil 52 with a polymer film 54 on both sides as shown in FIGURE may be used for the case 50. For example, aluminum foil may be used for the metal foil 52, and a film of polypropylene or the like may be used as the polymer film 54. For example, as the material of the external polymer film 54, a polymer with a high melting point such as polyethylene terephthalate (PET), polyamide or the like is preferable. As the material of the internal polymer film 54, polyethylene (PE), polypropylene (PP) or the like is preferable.

Leads

The leads 60 and 62 are formed of a conductive material such as aluminum. The leads 60 and 62 are welded to the positive electrode current collector 22 and the negative electrode current collector 32 by a known method, respectively, and the leads 60 and 62 are inserted into the case 50 together with the electrolytic solution in a manner in which the separator 10 is interposed between the positive electrode active material layer 24 of the positive electrode 20 and the negative electrode active material layer 34 of the negative electrode 30, and then the port of the case 50 is sealed.

Method of preparing lithium ion secondary battery

Next, a method of preparing the lithium ion secondary battery 100 will be described in detail.

First, a coating material is prepared by mixing a negative electrode active material, a binder, and a solvent. As necessary, a conductive material or a thickener may be further added. As the solvent, for example, water, N-methyl-2-pyrrolidone or the like may be used. The compositional proportion of the negative electrode active material, the conductive material, and the binder is preferably 92 mass % or more and 98 mass % or less; 0 mass % or more and 3.0 mass % or less; and 2.0 mass % or more and 5.0 mass % or less respectively by proportion by mass. Further, the compositional proportion of the negative electrode active material, the conductive material, the binder, and the thickener is preferably 92 mass % or more and 98 mass % or less: 0 mass % or more and 3 mass % or less: 1 mass % or more and 3 mass % or less: 0 mass % or more and 2 mass % or less by proportion by mass. These mass ratios are adjusted to be 100 mass % as a whole.

A method of mixing the above-described components forming the coating material together is not limited, and the order of mixing in is also not particularly limited. The negative electrode current collector 32 is coated with the coating material. A coating method is not particularly limited, and a general method adopted in the case of preparing an electrode may be used. Examples thereof include a slit die coating method, and a doctor blade method. Similarly for the positive electrode, the positive electrode current collector 22 is coated with a coating material for the positive electrode.

Subsequently, the solvent in the coating material with which the positive electrode current collector 22 and the negative electrode current collector 32 are coated is removed. A method of removing the solvent is not particularly limited. For example, the positive electrode current collector 22 and the negative electrode current collector 32 coated with the coating material may be dried in the atmosphere at 80 to 150° C.

Then, the electrodes having the positive electrode active material layer 24 and the negative electrode active material layer 34 formed thereon are pressed by a roll pressing device or the like as necessary.

Next, the positive electrode 20 having the positive electrode active material layer 24, the negative electrode 30 having the negative electrode active material layer 34, the separator 10 interposed between the positive electrode and the negative electrode, and the electrolytic solution are encapsulated in the case 50.

For example, the positive electrode 20, the negative electrode 30, and the separator 10 are stacked, and the positive electrode 20 and the negative electrode 30 are heated and pressed by a pressing tool in a direction perpendicular to the stacking direction, and the positive electrode 20, the separator 10, and the negative electrode 30 are closely adhered. Then, for example, the laminate 40 is placed in a bag-shaped case 50 which has been previously prepared.

Finally, a lithium ion secondary battery is prepared by injecting the electrolytic solution into the case 50. Further, the laminate 40 may be impregnated with the electrolytic solution instead of injecting the electrolytic solution into the case.

As described above, it is thought that since the negative electrode active material according to an embodiment of the present invention contains a sulfur component in a predetermined range, and sulfur atoms contained in the sulfur component are present on the surface or inside of the carbon material, the Li ion conductivity of the carbon material is thereby improved. Accordingly, the lithium ion secondary battery including the negative electrode active material according to an embodiment of the present invention has improved rapid charging characteristics.

Although embodiments of the present invention have been explained in detail with reference to the drawing, the individual structural elements and the combinations thereof in the embodiments are examples. Additions, omissions, substitutions, and other modifications may be made without departing from the scope of the present invention.

### EXAMPLES

### Example 1

Preparation of Negative Electrode Active Material

Artificial graphite (bulk density: 2.5 g/cm³, specific surface area: 0.05 m²/g, sulfur component content (in terms of S): 0.00005 mass % or less, potassium content: 0.0001 mass % or less) as a carbon material, and a sulfuric acid (H₂SO₄) solution as a sulfur source were prepared. The prepared artificial graphite and sulfuric acid solution were dry-mixed in a ball mill to prepare a negative electrode active material having a sulfur component content (in terms of S) of 0.0005 mass %. The content of the sulfur component (in terms of S) and the content of potassium were determined by a fluorescent X-ray analysis method. The artificial graphite was dropped into a container having a capacity of 100 cm³ from a 8 mmφ discharge portion of a funnel so that the container was filled with the artificial graphite, artificial graphite overflowing from the container was scraped off, the weight of the artificial graphite filled into the container was measured, and the bulk density was calculated from the weight of the artificial graphite measured and the volume of the container. The specific surface area was measured by a BET method by nitrogen gas adsorption using a specific surface area measuring device.

Preparation of Negative Electrode

94 parts by mass of the prepared negative electrode active material, 2 parts by mass of acetylene black as a conductive material, and 4 parts by mass of polyvinylidene fluoride (PVDF) as a binder were weighed out and mixed to obtain a negative electrode mixture. Subsequently, the negative electrode mixture was dispersed in N-methyl-2-pyrrolidone to prepare a paste-like negative electrode mixture coating material. Both sides of an electrolytic copper foil having a thickness of 10 μm were coated with the coating material so that the coating amount of the negative electrode active material was 6.1 mg/cm², and the coating material was dried at 100° C. to form a negative electrode active material layer. Thereafter, a negative electrode was prepared by pressure-molding with a roll press.

Preparation of Positive Electrode

90 parts by mass of LiCOO₂ as a positive electrode active material, 5 parts by mass of acetylene black as a conductive material and 5 parts by mass of polyvinylidene fluoride (PVDF) as a binder were weighed out and mixed to obtain a positive electrode mixture. Subsequently, the positive electrode mixture was dispersed in N-methyl-2-pyrrolidone to prepare a paste-like positive electrode mixture coating material. Both sides of an aluminum foil having a thickness of 20 μm were coated with the coating material so that the coating amount of the positive electrode active material was 12.5 mg/cm², and the coating material was dried at 100° C. to form a positive electrode active material layer. Thereafter, it was pressure-molded by a roll press to prepare a positive electrode.

Preparation of Lithium Ion Secondary Battery for Evaluation

The prepared negative electrode and positive electrode were alternately stacked with a polypropylene separator having a thickness of 16 μm interposed therebetween, and three negative electrodes and two positive electrodes were stacked to prepare a laminate. Further, in the negative electrode of the laminate, a negative electrode lead formed of nickel was attached to a protruding end portion of the copper foil at which the negative electrode active material layer was not formed, whereas in the positive electrode of the laminate, a positive electrode lead formed of aluminum was attached to a protruding end portion of the aluminum foil at which the positive electrode active material layer was not formed using an ultrasonic welding machine. Then, the laminate was inserted into an exterior body of an aluminum laminate film, and heat-sealed except for one portion around the periphery to form a closing portion. A nonaqueous electrolytic solution containing 1 M (mol/L) LiPF₆ as a lithium salt in a solvent in which EC (ethylene carbonate)/DEC (diethyl carbonate) were mixed together in the exterior body at a volume ratio of 3:7 was injected, and then the remaining one portion was sealed with heat while reducing the pressure with a vacuum sealing machine to prepare a lithium ion secondary battery.

Measurement of Rapid Charging Characteristics

The rapid charging characteristics of the prepared lithium ion secondary battery were measured using a secondary battery charging and discharge test apparatus. The voltage range was from 3.0 to 4.2 V, 1C=340 mAh/g per weight of the negative electrode active material, and evaluation was performed as a 3C capacity retention rate (%). Here, the 3C capacity retention rate is the ratio of the charge capacity at 3C constant current charging to a 0.2 C charge amount based on the constant current-constant voltage charge capacity in 0.2 C charging and is represented by the following Formula (1). Note that 1 C is a current value at which charging/discharging is completed in exactly one hour after constant current charging or constant current discharging of a battery cell having a capacity of a nominal capacity value.

3C capacity retention rate (%)=Charge capacity in 3C constant current charging/constant current-constant voltage charge capacity in 0.2C charging×100 (1)

### Examples 2 to 12 and Comparative Examples 1 to 4

In the preparation of the negative electrode active material, a lithium ion secondary battery was prepared in the same manner as in Example 1 except that the artificial graphite and the sulfuric acid solution were weighed out in proportions such that the sulfur component content (in terms of S) in the negative electrode active material was an amount shown in the following Table 1. Then, the rapid charging characteristics (3C capacity retention rate (%)) of the prepared lithium ion secondary battery were measured. The results are shown in Table 1.

TABLE 1

| | Sulfur component | |
|---|---|---|
| | content | 3 C capacity |
| | (in terms of S) | retention rate (%)) |
| Example 1 | 0.0005 | 80.1 |
| Example 2 | 0.0007 | 80.4 |
| Example 3 | 0.0010 | 84.2 |
| Example 4 | 0.0020 | 85.3 |
| Example 5 | 0.0030 | 85.4 |
| Example 6 | 0.0040 | 84.8 |
| Example 7 | 0.0045 | 81.2 |
| Example 8 | 0.0050 | 80.9 |
| Example 9 | 0.0070 | 78.2 |
| Example 10 | 0.0080 | 78.0 |
| Example 11 | 0.0090 | 75.1 |
| Example 12 | 0.0100 | 70.4 |
| Comparative Example 1 | 0.0001 | 52.1 |
| Comparative Example 2 | 0.0003 | 55.3 |
| Comparative Example 3 | 0.0200 | 59.8 |
| Comparative Example 4 | 0.0300 | 58.7 |

It was confirmed from the results shown in Table 1 that, in each of Examples 1 to 12 in which the sulfur atom content was 0.0005 mass % or more and 0.01 mass % or less, the 3C capacity retention rate exhibited a high value of 70% or more. In contrast, in each of Comparative Examples 1 to 4 in which the sulfur atom content was smaller or larger than the range of the present invention, it was confirmed that the 3C capacity retention rate exhibited a low value of 60% or less.

Further, it was confirmed that in each of Examples 1 to 11 in which the sulfur atom content was 0.0005 mass % or more and 0.009 mass % or less, the 3C capacity retention rate exhibited a high value of 75% or more. Particularly, it was confirmed that in each of Examples 1 to 8 in which the sulfur atom content was 0.0005 mass % or more and 0.005 mass % or less, the 3C capacity retention rate exhibited a high value of 80% or more.

### Examples 13 to 20

A lithium ion secondary battery was prepared in the same manner as in Example 1 except that the bulk density of the artificial graphite was adjusted by sieving the artificial graphite. That is, in the preparation of the negative electrode active material, a lithium ion secondary battery was prepared in the same manner as in Example 1 except that artificial graphite of which the bulk density was adjusted to the values shown in the following Table 2 was used as the carbon material. Then, the rapid charging characteristics (3C capacity retention rate (%)) of the prepared lithium ion secondary battery were measured. The results are shown in Table 2.

Further, the bulk density of Example 13 was adjusted by removing artificial graphite of 0 to 10% and 90 to 100% of the cumulative volume in an artificial graphite particle size distribution by sieving. Similarly, in Example 14, artificial graphite of 0 to 8% and 92 to 100% of the cumulative volume was removed. In Example 15, artificial graphite of 0 to 7% and 93 to 100% of the cumulative volume was removed. In Example 16, artificial graphite of 0 to 5% and 95 to 100% of the cumulative volume was removed. In Example 17, artificial graphite of 0 to 3% and 97 to 100% of the cumulative volume was removed. In Example 18, artificial graphite of 0 to 2% and 98 to 100% of the cumulative volume was removed. In Example 19, artificial graphite of 0 to 1% and 99 to 100% of the cumulative volume was removed. In Example 20, sieving was not performed (i.e., corresponding to Example 1). Accordingly, the bulk density of Table 2 was obtained without changing the specific surface area.

TABLE 2

| | Bulk density | 3 C capacity |
|---|---|---|
| | (g/cm³) | retention rate (%) |
| Example 13 | 0.2 | 80.1 |
| Example 14 | 0.4 | 80.4 |
| Example 15 | 0.5 | 84.3 |
| Example 16 | 1.0 | 84.9 |
| Example 17 | 1.5 | 85.0 |
| Example 18 | 2.0 | 84.4 |
| Example 19 | 2.2 | 80.2 |
| Example 20 | 2.5 | 80.1 |

It was confirmed from the results shown in Table 2 that the 3C capacity retention rate was improved by adjusting the bulk density of the artificial graphite. Particularly, in Examples 15 to 18 in which the bulk density was 0.5 g/cm³ or more and 2.0 g/cm³ or less, the 3C capacity retention ratio was significantly improved.

### Examples 21 to 28

A lithium ion secondary battery was prepared in the same manner as in Example 18 except that the specific surface area of the artificial graphite was adjusted by grinding the artificial graphite. That is, a lithium ion secondary battery was prepared in the same manner as in Example 18 except that artificial graphite of which the specific surface area was adjusted to have the values shown in the following Table 3 was used as the carbon material in the preparation of the negative electrode active material. Then, the rapid charging characteristics (3C capacity retention rate (%)) of the prepared lithium ion secondary battery were measured. The results are shown in Table 3.

Further, the artificial graphite was milled by dry milling using a ball mill. However, in Example 21, no milling was carried out (that is, it corresponds to Example 18). The milling time was 0.5 hours in Example 22, the milling time was 1 hour in Example 23, the milling time was 2 hours in Example 24, the milling time was 3 hours in Example 25, the milling time was 4 hours in Example 26, the milling time was 5 hours in Example 27, and the milling time was 6 hours in Example 28.

TABLE 3

| | Specific surface | 3 C capacity |
|---|---|---|
| | area (m²/g) | retention rate (%) |
| Example 21 | 0.05 | 84.4 |
| Example 22 | 0.07 | 84.5 |
| Example 23 | 0.10 | 87.9 |
| Example 24 | 0.50 | 88.1 |
| Example 25 | 1.00 | 88.5 |
| Example 26 | 2.00 | 87.8 |
| Example 27 | 2.20 | 84.2 |
| Example 28 | 2.50 | 83.9 |

It was confirmed from the results shown in Table 3 that the 3C capacity retention rate was improved by adjusting the specific surface area of the artificial graphite. Particularly, in Examples 23 to 26 in which the specific surface area was 0.1 m²/g or more and 2 m²/g or less, the 3C capacity retention ratio was markedly improved.

### Examples 29 to 34

A lithium ion secondary battery was prepared in the same manner as in Example 1 except that lithium sulfide (Li₂S), lithium sulfate.monohydrate (Li₂SO₄.H₂O), magnesium sulfate (MgSO₄), calcium sulfate (CaSO₄), barium sulfate (BaSO₄), and sulfur (S) were used as a sulfur source instead of a sulfuric acid solution to prepare a negative electrode active material having a sulfur component content (in terms of S) of 0.0005 mass %, and this negative electrode active material was used. Then, the rapid charging characteristics (3C capacity retention rate (%)) of the prepared lithium ion secondary battery were measured. The results are shown in Table 4.

TABLE 4

| | | 3 C capacity |
|---|---|---|
| | Sulfur source | retention rate (%) |
| Example 29 | Li₂S | 81.3 |
| Example 30 | Li₂SO₄•H₂O | 81.2 |
| Example 31 | MgSO₄ | 80.3 |
| Example 32 | CaSO₄ | 80.1 |
| Example 33 | BaSO₄ | 80.5 |
| Example 34 | S | 81.4 |

It was confirmed from the results shown in Table 4 that, also when a metal sulfide and a metal sulfate were used as a sulfur source, the 3C capacity retention rate was improved.

### Examples 35 to 38 and Comparative Examples 5 to 7

A lithium ion secondary battery was prepared in the same manner as in Example 21 except that, in the preparation of the negative electrode, the artificial graphite particles, the conductive material (acetylene black), the binder (SBR suspension), and the thickener (CMC solution) of Example 21 were mixed in so as to have the compositions shown in the following Table 5. Then, charge/discharge cycle characteristics of the prepared lithium ion secondary battery were measured. The results are shown in Table 5. Further, the content of the binder is the amount as SBR and the content of the thickener is the amount as CMC.

TABLE 5

| | Composition of negative electrode | | | | |
|---|---|---|---|---|---|
| | active material layer | | | | |
| | Negative | | | | |
| | electrode | Conduc- | | | 3 C |
| | active | tive | | Thick- | capacity |
| | material | material | Binder | ener | retention |
| | (mass %) | (mass %) | (mass %) | (mass %) | rate (%) |
| Example 35 | 92 | 3.0 | 3.0 | 2.0 | 85.0 |
| Example 36 | 95 | 2.0 | 2.0 | 1.0 | 85.9 |
| Example 37 | 98 | 0.0 | 1.0 | 1.0 | 85.8 |
| Example 38 | 98 | 1.0 | 1.0 | 0 | 85.8 |
| Comparative | 90 | 4.0 | 3.5 | 2.5 | 69.9 |
| Example 5 | | | | | |
| Comparative | 98 | 1.5 | 0.5 | 0 | 65.1 |
| Example 6 | | | | | |
| Comparative | 99 | 0 | 1 | 0 | 68.3 |
| Example 7 | | | | | |

It was confirmed from the results in Table 5 that, in Examples 35 to 38 in which the negative electrode active material was contained in an amount of 92 mass % or more and 98 mass % or less, the binder was contained in an amount of 1 mass % or more and 3 mass % or less, the conductive material was contained in an amount of 0 mass % or more and 3 mass % or less, and the thickener was contained in an amount of 0 mass % or more and 2 mass % or less, the 3C capacity retention rate was improved.

### Examples 39 to 45

A lithium ion secondary battery was prepared in the same manner as in Example 3 except that the same negative electrode as prepared in Example 3 was used, and in the preparation of a lithium ion secondary battery for evaluation, the mixing ratio of EC and DEC in the nonaqueous electrolyte was set to the amount shown in Table 6. Then, charge/discharge cycle characteristics of the prepared lithium ion secondary battery were measured. The results are shown in Table 6.

### Comparative Example 8

A lithium ion secondary battery was prepared in the same manner as in Comparative Example 3 except that the same negative electrode as prepared in Example 3 was used, and in the preparation of a lithium ion secondary battery for evaluation, the mixing ratio of EC and DEC in the nonaqueous electrolyte was set to the amount shown in Table 6. Then, charge/discharge cycle characteristics of the prepared lithium ion secondary battery were measured. The results are shown in Table 6.

TABLE 6

| | | | | 3 C capacity |
|---|---|---|---|---|
| | Content X of | Content Y of | X/Y | retention |
| | EC (volume %) | DEC (volume %) | (—) | rate (%) |
| Example 39 | 66 | 33 | 0.5 | 85.0 |
| Example 40 | 60 | 40 | 0.7 | 85.1 |
| Example 41 | 50 | 50 | 1.0 | 86.2 |
| Example 42 | 25 | 75 | 3.0 | 86.3 |
| Example 43 | 16.6 | 83.4 | 5.0 | 86.1 |
| Example 44 | 14.2 | 85.8 | 6.0 | 85.2 |
| Example 45 | 10 | 90 | 9.0 | 85.0 |
| Comparative | 25 | 75 | 3.0 | 58.3 |
| Example 8 | | | | |

It was confirmed that in Examples 41 to 43 in which the ratio X/Y of the content X of the EC to the content Y of the DEC was in the range of 1 or more and 5 or less as a volume ratio, the 3C capacity retention rate was improved.

### Example 46

3 g of the negative electrode active material prepared in Example 12 in 100 mL of an electrolytic solution (a solvent in which EC and DEC were mixed at a volume ratio of 3:7, a sulfur amount of 0.0003 mass % or less) was stirred for 10 hours. Next, after the negative electrode active material in the electrolytic solution was collected by filtration, the amount of sulfur in the electrolytic solution was measured by ICP-AES (high frequency inductively coupled plasma-atomic emission spectrometry). The result was that the amount of sulfur in the electrolytic solution was 0.0003 mass % or less, which was the same as before the negative electrode active material was immersed. The reason why the eluted amount of sulfur of the negative electrode active material was low as above is thought to be that sulfur and carbon were chemically bonded by a mechanochemical reaction when artificial graphite and sulfuric acid are mixed using a ball mill.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

10 Separator
20 Positive electrode
22 Positive electrode current collector
24 Positive electrode active material layer
30 Negative electrode
32 Negative electrode current collector
34 Negative electrode active material layer
40 Laminate
50 Case
52 Metal foil
54 Polymer film
60 and 62 Lead
100 Lithium ion secondary battery

What is claimed is:

1. A negative electrode active material, comprising a carbon material, and at least one sulfur component selected from the group consisting of sulfur atoms and a sulfur compound, wherein a content of the sulfur component with respect to a total amount of the carbon material and the sulfur component is 0.0005 mass % or more and 0.01 mass % or less in terms of S measured by a fluorescent X-ray analysis method, the carbon material is artificial graphite, and the artificial graphite has a bulk density of 0.2 g/cm³ or more and 2.5 g/cm³ or less.

2. The negative electrode active material according to claim 1, wherein the content of the sulfur component is 0.009 mass % or less in terms of S measured by a fluorescent X-ray analysis method.

3. The negative electrode active material according to claim 2, wherein the content of the sulfur component is 0.005 mass % or less in terms of S measured by a fluorescent X-ray analysis method.

4. The negative electrode active material according to claim 1, wherein the artificial graphite has a bulk density of 0.5 g/cm³ or more and 2.0 g/cm³ or less.

5. The negative electrode active material according to claim 2, wherein the artificial graphite has a bulk density of 0.5 g/cm³ or more and 2.0 g/cm³ or less.

6. The negative electrode active material according to claim 3, wherein the artificial graphite has a bulk density of 0.5 g/cm³ or more and 2.0 g/cm³ or less.

7. The negative electrode active material according to claim 1, wherein the artificial graphite has a specific surface area of 0.1 m²/g or more and 2 m²/g or less.

8. The negative electrode active material according to claim 2, wherein the artificial graphite has a specific surface area of 0.1 m²/g or more and 2 m²/g or less.

9. The negative electrode active material according to claim 3, wherein the artificial graphite has a specific surface area of 0.1 m²/g or more and 2 m²/g or less.

10. The negative electrode active material according to claim 4, wherein the artificial graphite has a specific surface area of 0.1 m²/g or more and 2 m²/g or less.

11. The negative electrode active material according to claim 5, wherein the artificial graphite has a specific surface area of 0.1 m²/g or more and 2 m²/g or less.

12. The negative electrode active material according to claim 6, wherein the artificial graphite has a specific surface area of 0.1 m²/g or more and 2 m²/g or less.

13. A negative electrode, comprising a negative electrode current collector, and a negative electrode active material layer formed on the negative electrode current collector, wherein the negative electrode active material layer includes the negative electrode active material according to claim 1.

14. The negative electrode according to claim 13, wherein the negative electrode active material layer contains the negative electrode active material in an amount of 92 mass % or more and 98 mass % or less, a binder in an amount of 1 mass % or more and 3 mass % or less, a conductive material in an amount of 0 mass % or more and 3 mass % or less, and a thickener in an amount of 0 mass % or more and 2 mass % or less.

15. A lithium ion secondary battery, comprising the negative electrode according to claim 13, a positive electrode, and an electrolytic solution.

16. The lithium ion secondary battery according to claim 15, wherein the electrolytic solution contains a cyclic carbonate and a chain carbonate, and a ratio X/Y of a content X of the cyclic carbonate to a content Y of the chain carbonate is in a range of 1 or more and 5 or less as a volume ratio.
